(19) United States
(12) Patent Application Publication
(10) Pub. No.: US 2002/0065663 A1
(43) Pub. Date: May 30, 2002

(54) Communication of network address information

(76) Inventors: Andrew Thomas, Atherton, CA (US); Paul St. John Brittan, Claverham (GB)

Correspondence Address: LOWE HAUPTMAN GOPSTEIN, GILMAN AND BERNER LLP, SUITE 310, 1700 DIAGONAL ROAD, ALEXANDRIA, VA, 22314

(21) Appl. No.: 09/994,934

(22) Filed: Nov. 28, 2001

(30) Foreign Application Priority Data
Nov. 29, 2000 (GB) 0029024.7

(51) Int. Cl. G10L 11/00; G10L 21/00

(52) U.S. Cl. 704/275; 709/218

(57) ABSTRACT

Many network addresses on the public or private networks are currently expressed and passed verbally in domain name format because this is a much easier for humans than using a numeric address form. However, verbal expression and recognition of network addresses in domain name form is a non-trivial task for machines and this hinders the adoption of speech interfaces for the passing of addresses. Therefore, in order to facilitate passing addresses in speech form to and from machines, the machines are enabled speak their addresses in number form with their speech synthesis and recognition vocabularies being correspondingly restricted.

### FIELD OF THE INVENTION

The present invention relates to the passing of network address information to and from network-connected devices and in particular, but not exclusively, to the passing of IP addresses.

### BACKGROUND OF THE INVENTION

Computer network addresses at their lowest level of expression are binary strings. For the IPv5 protocol that is widely adopted and forms a core protocol of the public internet, a network address is 32 bits long which is unmanageable for human verbal usage. Consequently, the so-called “dotted decimal” format is generally used for the expression (written or verbal) of IP addresses in the technical community. In this format, each 8 bits of the 32 IP address is expressed as a decimal number in the range 0 to 255; each of the four resultant numbers is separated by a “dot” from its neighbour. An example dotted decimal IP address is:

128.10.2.30

Even this format is unpalatable for the non-technical and therefore domain and machine names are widely used for identifying sites, particularly on the public internet. Thus, the US Patent & Trademark Office public internet server is located at “www.uspto.gov” which is easily remembered by a human; however, before a machine can use this address to contact the US PTO server, it must first have the address translated into a numeric IP address by the Domain Name System of the internet.

The passing of network address information is often done verbally and, as already indicated, humans prefer to use the domain name form of address. However, verbal expression and recognition of network addresses in domain name form is a non-trivial task for machines and this hinders the adoption of speech interfaces for the passing of addresses.

It is an object of the present invention to provide devices and methods facilitating the spoken communication of network addresses to, from and between network-connected machines.

### SUMMARY OF THE INVENTION

According to one aspect of the present invention, there is provided a device with network connectivity, the device including a speech subsystem for speaking the network address of the device in number form. The network address is, for example, an IP address which the speech subsystem is arranged to speak in dotted decimal format. For reasons of cost and simplicity, the speech subsystem preferably has only a minimum vocabulary required for speaking network addresses (for IP addresses in dotted decimal format this vocabulary comprises the ten digits and possibly the word “dot” or “point” and, for IPv6, also colons).

According to another aspect of the present invention, there is provided a device for receiving and understanding network addresses spoken in number form, the device comprising an audio input transducer connected to a speech recogniser, the speech recogniser being operative to recognise a vocabulary substantially restricted to the minimum required for network addresses in number form.

According to a further aspect of the present invention, there is provided a device for speaking network addresses in number form, the device comprising an audio output transducer connected to a speech synthesiser, the speech synthesiser being operative to speak a vocabulary substantially restricted to the minimum required for speaking network addresses in number form.

The minimum vocabulary may be supplemented with a few command words and the like to facilitate operation.

The present invention also encompasses methods of passing network addresses corresponding to the methods implemented by the foregoing devices.

### BRIEF DESCRIPTION OF THE DRAWINGS

A method and apparatus embodying the invention, for communicating IP addresses by voice, will now be described, by way of non-limiting example, with reference to the accompanying diagrammatic drawings, in which:

FIG. 1 is a diagram showing the passing of the IP address of a first device to a second device using speech to convey the address via a human user;

FIG. 2 is a diagram similar to FIG. 1 but showing the IP address being output visually by the first device to the human user;

FIG. 3 is a diagram similar to FIG. 1 but showing the IP address being input by the human user into the second device using a keyboard;

FIG. 4 is a diagram showing the passing of the IP address of a first device to a second device using speech to convey the address via a capture device;

FIG. 5 is a diagram similar to FIG. 4 but showing the IP address being output over an infrared link by the first device to the capture device;

FIG. 6 is a diagram similar to FIG. 4 but showing the IP address being transmitted by the capture device over an infrared link to the second device; and

FIG. 7 is a diagram showing the passing of the IP address of a first device directly from the first device to a second device using speech.

### BEST MODE FOR CARRYING OUT THE INVENTION

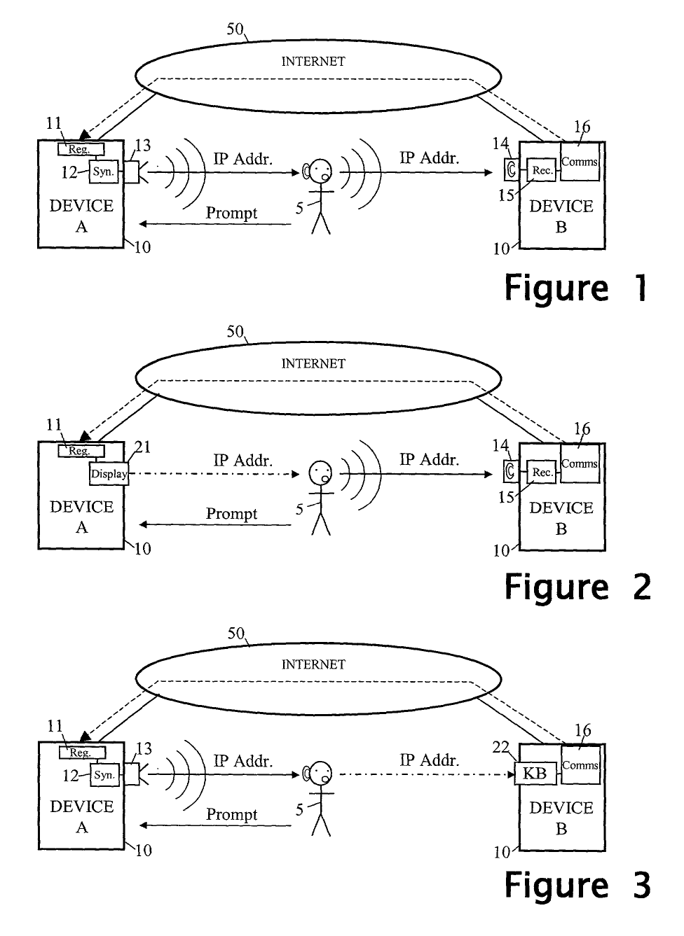

Referring to FIG. 1, user 5 wishes to get two devices 10 (hereinafter devices A and B respectively) to talk to each other over the public internet 50 (or other compute network) to which they are both connected. This is achieved by device A speaking its address to user 5 who subsequently repeats the address verbally to device B which then uses the address to connect to device A across the internet (and, in doing so, pass device B's own address to device A).

More particularly, device A includes a network interface with memory register 11 that holds its IP address identifying uniquely its connection to the internet 50, this address either being a permanent (or semi-permanent) address or an address that is dynamically determined each time the device connects to the internet. Device A also includes a speech synthesiser 12 connected to read the address in register 11 and output it in speech form through loudspeaker 13, this being done in response to a user prompt received at user input interface (not shown) of device A. This prompt can take any convenient form such as a key press or clap of the hands. The synthesiser is arranged to speak the IP address in dotted decimal form and is given a minimum vocabulary for this purpose. For IPv5, this vocabulary can be restricted to the ten decimal digits and “dot” or “point” assuming that a number such as “128” is spoken as “one”+“two”+“eight”. Where the number is to be spoke as “one hundred and twenty eight”, then additional words are required and this is not preferred. In fact, even the “dot” or “point” word can be omitted provided an adequate pause is left between the four number groups of the dotted decimal address format. Thus with a minimal vocabulary, all IP addresses can be generated and spoken by the synthesiser 12.

Where the IPv6 protocol is also to be accommodated, then “colon” is also required as part of the synthesiser's vocabulary.

The user 5 hears the address spoken by device A and repeats it, either immediately or after a delay, to device B. This device includes a microphone 14 feeding a speech recogniser 15. The recogniser is arranged to recognise a minimum required vocabulary corresponding to that used by the synthesiser (possibly with the addition of start/stop key words to start and stop address recognition). Provided the user repeats the IP address of device A clearly, and in dotted decimal form, the recogniser 15 can readily recognise the address and pass it to a communications block 16 in a form usable by the latter and the network. The block 16 then uses the address to contact device A over the public internet via a network interface (not shown) of block 16, the address being used as the destination address of a message sent to the device A.

Since the English form of the basic decimal numbers is widely known, it will generally be unnecessary to provide for the speech recogniser to understand different languages—using only English further simplifies the synthesiser and recogniser.

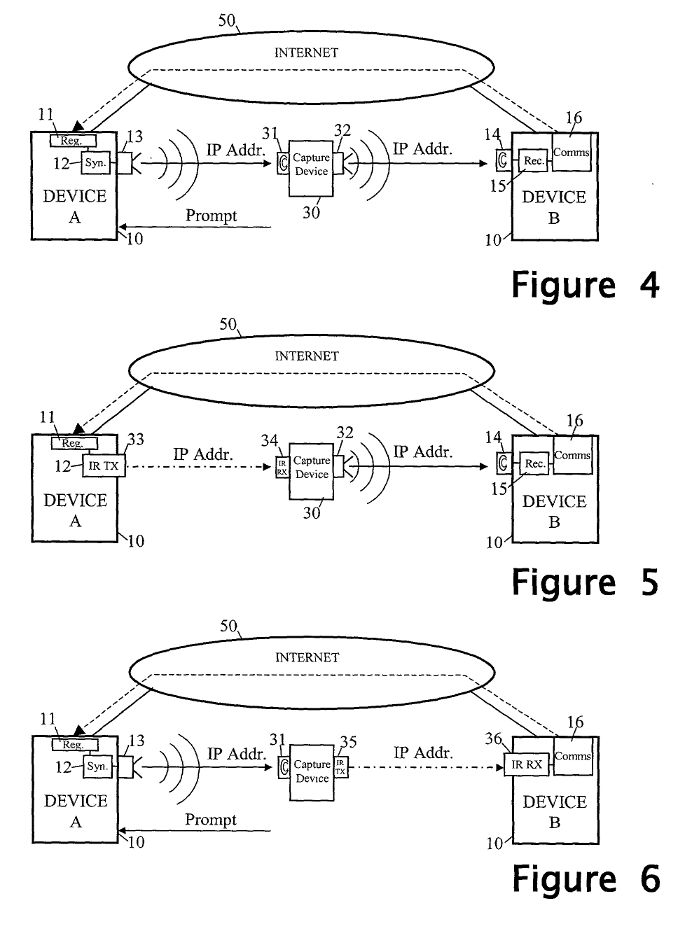

FIGS. 2 and 3 show variants of the FIG. 1 arrangement. In FIG. 2, device A does not speak its IP address but simply displays it on display 21 in dotted decimal format for the user to read and repeat aloud to device B which is still equipped with recogniser 15. In FIG. 3, device A speaks its IP address as in the FIG. 1 arrangement but now the user inputs the address into device B via a keyboard 22 rather than by speaking.

FIG. 4 shows an arrangement where the role of the user 5 in FIG. 1 is replaced by a capture device 30. This device has a microphone 31 for hearing the IP address spoken by device A, the microphone feeding a speech recogniser (not shown) of similar form to recogniser 15 of FIG. 1. Recogniser stores the resultant IP address in internal memory (not shown) of the capture device. When commanded by the user 5, the capture device outputs the IP address in dotted decimal form by retrieving the address from its internal memory and passing it to a speech synthesiser (not shown) of the device 30, the synthesiser feeding a loudspeaker 32. The spoken address is received, recognised and used by device B in the same manner as in the FIG. 1 arrangement.

The capture device can be arranged to hold multiple IP addresses in its internal memory in which case appropriate selection means are provided for enabling the user 5 to select which of the stored IP addresses is to be spoken by the device.

The vocabulary of the speech recogniser and speech synthesiser of the capture device 30 are given the same restricted vocabulary as the corresponding elements of devices A and B.

FIGS. 5 and 6 show variants of the FIG. 4 arrangement. In FIG. 5, device A does not speak its IP address but simply sends it, in numeric form, by a short range wireless link to the capture device 30—in the present example, this link is an infrared link with device A being equipped with an infrared transmitter 33 and capture device 30 with an infrared receiver 34. Other forms of short-range wireless link, such as a Bluetooth radio link, can alternatively be used. The capture device stores the IP address and, when instructed, repeats it aloud to device B which is still equipped with recogniser 15. Device A can be arranged to continually transmit its address in numeric form in which case no user prompt is required.

In FIG. 6, device A speaks its IP address as in the FIG. 1 arrangement but now the capture device 30 transmits the address, on command, to device B using a short-range wireless link, again shown as an infrared link with the capture device 30 having an infrared transmitter 35 and device B and infrared receiver 36.

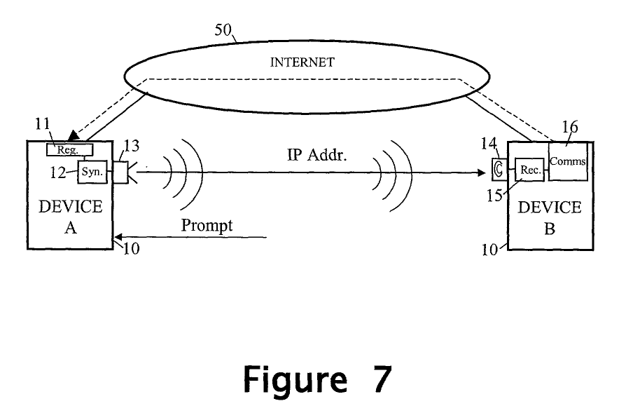

FIG. 7 is similar to FIG. 1 but shows an arrangement where device A speaks directly to device B without user 5 acting as an intermediary. This situation is likely to occur if device A and/or device is a portable device that has been brought close to the other device enabling one to speak directly to the other.

Many further variants are, of course, possible to the arrangements described above. For example, device A or device B may, in fact, have a much fuller speech capability for other reasons not connected with the passing of IP addresses.

Numeric addresses other than IP network addresses can be passed in similar manner with appropriate adaptation to the vocabulary of the speech recogniser/speech synthesiser to take account of special characters (such as the “dots” and “colons” of IP addresses expressed in dotted decimal form).

The speech input/output to/from a device can be effected over a voice communication channel. Thus in the FIG. 7 arrangement, the devices A and B need not be in close proximity but device A could be speaking over a telephone connection to device B. Similarly, for the arrangements of FIGS. 4 and 5, the capture device could be used to play back an IP address in spoken form over the telephone connection to device B whilst for the arrangements of FIGS. 1 and 2, the user can speak to device B over a telephone connection.

1. A device including:
a network interface for interfacing the device with a computer network, the network interface including a memory for storing a network address of the device; and
a speech subsystem for speaking said network address in number form.

2. A device according to claim 1, further including:
a user-input interface for receiving an output-prompt input from a user, the user-input interface being responsive to receiving said output-prompt input to cause the speech subsystem to speak said network address.

3. A device according to claim 1, wherein the network address is an IP address, the speech subsystem being arranged to speak the network address in dotted decimal format.

4. A device according to claim 1, wherein the vocabulary of the speech subsystem is substantially restricted to a minimum vocabulary required for speaking IP network addresses.

5. A device according to claim 1, wherein the speech subsystem is arranged to speak the network address only in English.

6. A device comprising:
a recogniser subsystem comprising an audio input transducer, and a speech recogniser operative to recognise computer network addresses input in spoken number form to the audio input transducer; and
a communications subsystem operative to receive from the recogniser subsystem a said computer network address recognised by the recogniser subsystem, and to send a message over the network using that address as a destination address of the message.

7. A device according to claim 6, wherein the vocabulary of the recogniser subsystem is substantially restricted to a minimum vocabulary required for recognising IP network addresses.

8. A devices according to claim 6, wherein the speech recogniser is operative to recognise IP addresses spoken in dotted decimal form in the English language.

9. A method for the output of the computer address of a device having computer network interface, the method comprising the steps of:
retrieving the current network address of the device from a memory of the network interface of the device; and
outputting the retrieved network address in spoken number form.

10. A method according to claim 9, wherein the network address is output in response to a prompt from a user.

11. A method according to claim 9, wherein the network address is an IP address, the address being output in spoken dotted decimal format.

12. A method by which a first device can communicating with a remote second device over a computer network, the method comprising the steps of:
(a) receiving in spoken number form the computer network address of the second device and transforming the address into a network usable form;
(b)sending a message from the first device over the computer network using the transformed address formed in step (a) as a destination address of the message.

13. A device according to claim 12, wherein the network address is an IP network address received in spoken dotted format.

14. A method by which a first device can communicating with a remote second device over a computer network, the method comprising the steps of:
(a) at the second device, retrieving the current network address of the device from a memory of the network interface of the device and outputting the retrieved network address in spoken number form;
(b) passing the network address of the second device in spoken number form directly, or via a voice transmission system, to the first device; and
(c) at the first device, receiving in spoken number form the computer network address of the second device, transforming the address into a network usable form, andsending a message from the first device over the computer network using the transformed address as a destination address of the message.

15. A device according to claim 12, wherein the network address of the second device is an IP network address, this address being output in step (a) in spoken dotted format.
